(19) United States
(12) Patent Application Publication
(10) Pub. No.: US 2017/0259370 A1
(43) Pub. Date: Sep. 14, 2017

(54) METHOD OF ASSEMBLING TWO SHEET METAL COMPONENTS SUCH AS VEHICLE BODYWORK COMPONENTS

(71) Applicant: PEUGEOT CITROEN AUTOMOBILES SA

(72) Inventor: Romaric Lenoir, Le Port Marly (FR)

(21) Appl. No.: 15/506,473

(22) PCT Filed: Sep. 11, 2015
(86) PCT No.: PCT/FR2015/052435

§ 371 Date: Feb. 24, 2017

(30) Foreign Application Priority Data
Sep. 16, 2014 (FR) 1458694

(51) Int. Cl. B23K 11/00; B62D 27/02; B23K 11/34; B23K 26/60; B23K 11/11; B23K 26/22

(52) U.S. Cl. CPC B23K 11/0026; B23K 11/11; B23K 26/22; B23K 11/34; B23K 26/60; B62D 27/026; B23K 2201/18

(57) ABSTRACT

The invention relates to a method of assembling two sheet metal elements (1, 1′), involving applying a bead of adhesive to a first element, assembling the second sheet metal element on the first and securing it by spot welds to hold the two sheet metal elements stationary before curing the adhesive. The invention consists in the fact that the bead of adhesive is applied discontinuously to the first sheet metal element (1) along an adhesive line and then, once the second sheet metal element (1′) has been pressed against the first, the two elements (1, 1′) are held fixed together by creating spot welds on sections of the discontinuous adhesive line that are devoid of adhesive.

### CROSS-REFERENCE TO RELATED APPLICATIONS

This application is the US National Stage of International Application PCT/FR2015/052435 which was filed Sep. 11, 2015, and published as WO2016/042240, which derives priority from French App. No. 1458694 filed Sep. 16, 2014 and which are hereby incorporated by reference.

### BACKGROUND

The present invention relates to a method of assembling two sheet metal components, such as vehicle bodywork components.

It is common in the auto industry to produce assemblies of sheet metal components by welding and/or gluing. Such sheet metal components, when they are used as bodywork components, must also meet the requirements of mechanical strength and rigidity.

Also, to gain strength, the use of adhesion known as structural has been developed in the automotive industry with the help of adhesives of the epoxy adhesive type or a polyurethane elastomer.

In general, the gluing of the components and their assembly is not final until the moment of polymerization (curing) of the adhesive. Within the framework of the automotive industry, this gluing and assembly occur during the stage of manufacturing in which the so-called rail body is assembled. The polymerization of the adhesive occurs most often at the cataphoresis (electrophoresis) step at the paint shop, but some types of adhesive can be polymerized at room temperature. It is therefore necessary to maintain the joined together components with respect to each other before polymerization of the adhesive has taken place.

Holding of the joined-together components immobile with respect to each other therefore takes place over a rather long period of time, and especially during the whole process of manufacturing the rail body. It is therefore necessary to be able to guarantee this hold, and it is then necessary to use another assembly method to attach the parts relative to one another, while the curing of the adhesive has not yet taken place.

It is therefore usual to assemble sheet metal components, by first forming an adhesive seam deposited in a linear and continuous manner, and then creating electrical spot welds (PSE) through the adhesive seam thus formed, in order to guarantee the hold of the assembled components until the moment pf polymerization of the adhesive.

During the welding process, a temperature equivalent to the melting point temperature of the metal to be welded must be reached, for example, a temperature of 1600° C. for steel. The resulting release of heat around the spot weld causes disadvantages, such as degradation of the rigidity properties of the adhesive, through which the weld has been effected and releases of toxic products associated with the degradation of the adhesive by the burning.

It was thus possible to observe a loss of 35% of the rigidity between an assembly made with an adhesive alone, and an assembly made with an adhesive plus an electrical spot weld. In addition, the formation of burned dusts and formaldehydes requires the use of expensive and costly ventilation systems, and whose effectiveness still is only partial.

Moreover, the adhesive exhibits poor electrical conductivity, which causes disturbances or interruptions in the resistance welding process, and can even generate flash-like defects (such as expulsion and cracking of the spot weld).

US2007/0175867 proposed to provide an attachment via welding reinforced with an adhesive; the adhesive being polymerized by spot welds being made evenly by spots using the same electrode but at different locations; however, the spot welds are produced through the deposited adhesive, which again generates the same disadvantages during welding.

JP 07-314172 proposed to produce an assembly between two elements, in which a terminal spot weld is produced at the end of an adhesive line.

In order to avoid these disadvantages, it was proposed in EP 1 782 908 to produce an assembly method combining an adhesion made between the edge of the two assembled sheets, combined with an electrical resistance welding, arranged away from the edge and from the adhesive line. While this avoids electrical spot welding in the bonding process, this method has the disadvantage of using an assembly width that is too large and, in fact, too expensive regarding material.

It has also been proposed to produce an assembly of sheet metal components, combining gluing and spot welding as described in EP 1 660 270, in which one of the components to be assembled has recesses, forming by way of assembling on the other component, housings in which an adhesive can be inserted, while between the recesses, electrical spot welds are produced. Such a method therefore makes it possible to eliminate the disadvantages associated with welding through a bead of adhesive, since the fused parts of the assembly are distinct from the welded parts. However, it has been observed that, at the fusion stage, the presence of the housings receiving the adhesive generates a certain thickness of adhesive, which disturbs the rigidity properties of the component obtained by this method.

### SUMMARY

The object of the present invention is therefore to overcome all of these disadvantages, and to propose an assembly method which, while combining spot welding with gluing, makes it possible to eliminate the disadvantages associated in particular with the burning of the adhesive, while still retaining the properties of the assembly produced, in particular with regard to the rigidity of the vehicle bodywork component thus obtained.

To this end, a method of assembling two metal sheet elements is disclosed, wherein the method comprises the depositing of a bead of adhesive onto a first sheet metal element, then assembling the second sheet metal element to the first sheet metal element, and fusion of the sheet metal elements by forming spot welds to keep the two sheet metal elements immobile, before proceeding to the curing of the adhesive, characterized in that the bead of adhesive is deposited discontinuously along an adhesive line on the first sheet metal element, and then once the second sheet-metal element is pressed against the first element, the two elements are held stationary relative to one another by producing spot welds in the adhesive-free sections of the discontinuous adhesive line.

Thus, advantageously, the spot welds are produced along the adhesive line, but outside the deposited adhesive, which makes it possible to avoid all the risks of fumes associated with the burning of the adhesive. Moreover, since the adhesive is trapped between the two assembled sheet metal elements, the assembly thus produced can undergo the steps of the subsequent electrophoresis process without the risk of the adhesive being dislodged during washing steps, as would be the case if the adhesive had been housed in open recesses of a sheet metal element as described in EP 1 660 270.

Preferably, the spot welds are produced by electrical spot welding (also known as a PSE spot welding), by laser spot welding. These welding points are thus made by means of transparent welding on the two assembled elements. These spot welds are preferably made in alignment with the bead of adhesive, which does not require the use of a large surface width of the elements for assembly. Nevertheless, it is possible to produce these spot welds also along a welding line, aligned with the adhesive line, but spaced from it by an interval of, for example, at most 5 mm.

The method therefore makes it possible to obtain a bead of structural adhesive, with welding having none of the abovementioned disadvantages but which, moreover, makes it possible to fix the geometry of the assembly as long as the adhesive has not yet polymerized. In addition, all the required qualities of rigidity are maintained by using a braze bonding, by combining resistance welding points with a discontinuous line of structural adhesive at the interface between the assembled components or elements.

According to a preferred embodiment of the method, a bead of adhesive must be deposited so as to obtain a clearance between the two sheet metal elements of between 0.1 and 2 mm, preferably between 0.2 and 0.3 mm. The optimum clearance value is applicable with respect to the mechanical strength performance of the connection. When the thickness of adhesive increases, the performance of breaking strength decreases, in particular for the shear stresses type. It is therefore necessary to control the clearances and thicknesses of these connections in order to maintain a good level of performance.

The adhesive is thus deposited so as to form a discontinuous adhesive line, formed by “dashes” of deposited adhesive, between which welds are made. These adhesive dashes may be rectilinear or curved, which may in particular follow the shape of the assembly edge. At least one spot weld may be provided in each adhesive-free section of the adhesive line, between two adhesive dashes, or at a different frequency, such as a spot weld in an adhesive-free section between every two dashes of adhesive, etc. It is also possible to contemplate producing more than one spot weld in an adhesive-free section, between two dashes of adhesive.

The method is particularly advantageous in connection with the assembly of sheet metal structure elements intended to comprise a motor vehicle body. Another object of the invention is therefore a motor vehicle body, comprised at least in part by elements assembled according to the method, as well as a motor vehicle made at least in part of sheet metal elements (structural elements, body element) assembled according to the method, in particular a motor vehicle provided with such a body. Indeed, spot welding makes it possible to keep the fused-together components immobile relative to one another during the assembly phase of the elements comprising the body in the body shop, and thus to fix the geometry of the assembly before the adhesive is cured by polymerization in the paint shop, at the time of the so-called electrophoresis process. Some adhesives used can cure at room temperature.

The method makes it possible to guarantee the control of the mechanical properties of the adhesive seam (the latter being no longer degraded, as could be the case during welding), the absence of hazards during the production of the spot welds, as was the case for those made in the adhesive seam, and also avoids the release of toxic products into the atmosphere, which was linked to the burning, thus guaranteeing the safety of the operators in the vicinity.

### DESCRIPTION OF THE FIGURES

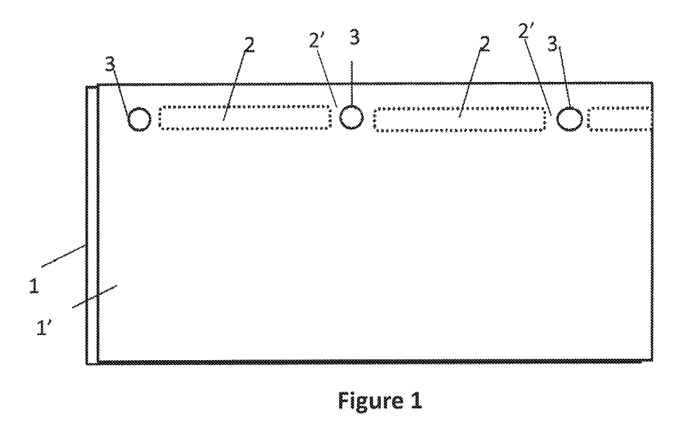

The invention will now be described in greater detail, with reference to the drawing in which the individual FIGURE (FIG. 1) represents a plan view of the edge of an assembly produced according to the invention.

### DESCRIPTION

In the manufacturing process of a motor vehicle, the assembly of the sheet-metal elements to form the rail body is effected by structural bonding, making it possible to increase the rigidity of the bodywork elements thus formed. In order to hold the fused-together elements immobile with respect to one another, and thus to fix the geometry of the bodywork elements until the moment of curing of the adhesive during the electrophoresis process, spot welding of these elements is carried out.

For this purpose, a bead of adhesive is deposited in a discontinuous manner on a sheet metal element 1, a second sheet metal element 1′ is assembled upon the first sheet metal element, and a resistance spot welding of the two sheet metal elements 1, 1′ is performed in the adhesive-free spaces or sections 2′ of the bead, or of the discontinuous adhesive seam. Thus, as can be seen in the FIGURE, the assembly line between the two sheet metal elements 1, 1′ is comprised of sections or dashes of adhesive 2 between which there are situated electric spot welds 3, such as, for example, a dash of adhesive, a spot weld, a dash of adhesive, a spot weld, etc.

The deposited adhesive bead sections 2 are calibrated according to the type of adhesive (epoxy, polyurethane) so that, during assembly, the bead of adhesive 2 forms a film between the two elements 1, 1′, whose thickness is between 0.2 and 0.3 mm, which corresponds to a gap between the sheet metal elements 1,1′ of between 0.2 and 0.3 mm. Preferably, the diameter of the deposited bead of adhesive corresponds to the clearance after assembly between the elements to which 2 mm is added.

If the clearance between the elements to be assembled is too large (greater than 1 mm), a loss of rigidity of the fusion thus produced can occur. In addition, if this clearance exceeds 2 mm, there is a risk of washing the adhesive (dislodged adhesive) during the washing step of the electrophoresis process.

Similarly, the depositing pitch of the bead of adhesive sections 2 is chosen so that the dispersion of the adhesive during assembly, and therefore spreading of the adhesive between the two elements, leaves a space 2′ free adhesive in order to produce a spot weld 3 by electrical resistance. Thus, the position of the bead of adhesive sections 2 is synchronized with the position of the spot welds 3. It is thus ensured that the spot welds 3 will not be made on the bead of adhesive.

Thus, by way of example, lengths of the beads 2 of adhesive can be deposited with a length of 120 mm and provide the adhesive-free sections 2′ with a length of 15 to 20 mm.

Preferably, dashes of adhesive are produced with a length of between 20 and 200 mm and the adhesive-free sections are produced with a length of between 15 and 50 mm. It is thus also possible to contemplate making the spot weld at a distance of 15 to 25 mm from a dash of adhesive, that is to say, an adhesive-free section of 30 to 50 mm between two successive dashes of adhesive.

The bead of adhesive once flattened by assembly between the two sheet metal elements preferably has a width of at least 10 mm.

The method of assembly of the invention therefore makes it possible to produce, during the stage of fastening, a rail body that maintains all its geometry. The rail body is then brought to the electrophoresis stage where the adhesive will be polymerized, fixing the assembly permanently.

1. A method of assembling two metal sheet elements comprising depositing a bead of adhesive on a first sheet-metal element, assembling of a second sheet-metal element on the first sheet-metal element, and positionally fixing two sheet metal elements relative to each other by forming spot welds until the adhesive is cured, wherein the bead of adhesive is deposited discontinuously along an adhesive line on the first sheet metal element to define adhesive-free sections along the discontinuous adhesive line, and then the second sheet metal element is pressed against the first sheet metal element, and the two sheet-metal elements are held immobile relative to each other by forming welding points at the adhesive-free sections of the discontinuous adhesive line.

2. The method of assembly according to claim 1, wherein the two sheet metal elements joined by the adhesive have a clearance of between 0.1 and 15 mm.

3. The method of assembly according to claim 1, wherein the clearance is between 0.2 and 0.3 mm.

4. The method of assembly according to claim 1, wherein the adhesive is of the epoxy, polyurethane type.

5. The method of assembly according to claim 1, wherein the spot welding is an electrical resistance welding.

6. The method of assembly according to claim 1, wherein the spot welding is laser welding.

7. The method of assembly according to claim 1, wherein the discontinuous adhesive line defines adhesive dashes which have a length of between 20 and 200 mm and wherein the adhesive-free sections have a length of between 15 and 50 mm.

8. The method of assembly according to claim 1, wherein the bead of adhesive, which is flattened by assembly between the two elements, preferably has a width of at least 10 mm.

9. A motor vehicle body wherein the body is at least partially formed from sheet metal elements joined by the method of assembling sheet metal elements according to claim 1.

10. A motor vehicle comprised at least in part of sheet metal elements assembled together according to the method of claim 1.
